(19) United States
(12) Patent Application Publication
(10) Pub. No.: US 2008/0230129 A1
(43) Pub. Date: Sep. 25, 2008

(54) Device for Fluid Transport

(75) Inventor: Robert Huw Davis, Hengoed (GB)

Correspondence Address: FROMMER LAWRENCE & HAUG, 745 FIFTH AVENUE- 10TH FL., NEW YORK, NY, 10151, US

(73) Assignee: Q CHIP LIMITED, Cardiff Bay (GB)

(21) Appl. No.: 11/792,346

(22) PCT Filed: Dec. 6, 2005
(86) PCT No.: PCT/GB05/04689

§ 371 Date: May 7, 2008

(30) Foreign Application Priority Data
Dec. 6, 2004 (GB) 0426766.2
Feb. 7, 2005 (GB) 0502443.5

(51) Int. Cl. G05D 7/00; B01J 19/00; B01F 5/00

(52) U.S. Cl. 137/597; 422/129

(57) ABSTRACT

A device (1) for producing multiple fluid flows at substantially uniform rates, which device includes: A manifold (2) having a first inlet port (3) and a second inlet port, each inlet port arranged to provide fluid transfer from the inlet port to a respective annular channel (4, 5, 6), a distribution element (7) having a first aperture set (12) and a second aperture set (13) therein, each aperture set including at least one aperture and being arranged to be in fluid communication with one of the annular channels such that fluid is permitted to flow from the annular channel through an aperture to a respective fluid outlet.

The present invention is concerned with a device for producing two or more fluid flows at substantially uniform rates.

It is desirable in many fields, especially in microfluidic circuits to produce simultaneous multiple uniform fluid flows. Apparatus currently used is undesirable because it has a number of limitations including non uniform flow distribution, pressure and flow pulsation.

Therefore, it is an aim to alleviate at least some of the disadvantages identified above.

It is a further aim of the present invention to provide apparatus which is capable of producing simultaneous multiple uniform fluid flows.

Therefore, according to a first aspect of the present invention, there is provided a device for producing multiple fluid flows at substantially uniform rates, which device includes:

a manifold having a first inlet port and a second inlet port, each inlet port arranged to provide fluid transfer from the inlet port to a respective annular channel;
a distribution element having a first aperture set and a second aperture set therein, each aperture set including at least one aperture and being arranged to be in fluid communication with one of the annular channels such that fluid is permitted to flow from the annular channel through an aperture to a respective fluid outlet.

It is envisaged that a fluid according to the present invention may be a liquid, gas, vapour or supercritical fluid.

It is preferred that the device of the present invention is suitable for distributing fluids to multiple microfluidic circuits. In this case, it is preferred that at least one of, and more preferably each of, the annular channels has a diameter from about 50 mm to about 300 mm. It is further preferred that the mean width of at least one of, and preferably each of, the annular channels is from about 1 mm to about 5 mm. It is further preferred that the mean depth of at least one of, and preferably each of, the annular channels is from about 1 mm to about 5 mm. It is preferred that the diameter of at least one of, and preferably each of, the apertures is from about 0.1 mm to about 3 mm, more preferably from about 0.5 mm to about 1.8 mm.

As previously mentioned, it is preferred that the device of the present invention is suitable for distributing fluids to multiple microfluidic circuits. The term “microfluidic” may be defined in relation to one or both of the flow rate through such a circuit and the size of the conduits in the circuit. In use, the flow through a typical microfluidic circuit is of the order of between 0.1 ml/hour to 100 ml/hour. Such microfluidic circuits typically comprise conduits having widths and depths of between 0.05 and 2 mm.

It is particularly preferred that each aperture set includes two or more apertures. Each aperture is preferably arranged to permit fluid to flow from the annular channel to the fluid outlet. It is particularly preferred that each aperture has a distinct fluid outlet.

The annular channel may be continuous or broken. A broken channel has one or more breaks, each break being located between two adjacent apertures of an aperture set having two or more apertures. Such a break in the channel prevents flow in a channel between the two adjacent apertures. Such a break in the channel is anticipated to be small, for example, having an angular dimension of 60 degrees or less, and preferably 45 degrees or less, more preferably 36 degrees or less. It is preferred that a break is provided between the two apertures that are most remote from the respective inlet port, because it has been found that there is a “dead space” between these two apertures in which there is little flow. This presents difficulties in cleaning the device. A break may be provided by a blocking insert placed in a previously-continuous, complete channel. Alternatively, the break in the channel may be provided by failing to form a part of the channel that, if formed, would make a continuous, complete channel.

According to a particularly preferred embodiment of the present invention, each aperture in each set is spaced apart by an equidistant amount. Each aperture set includes a plurality of apertures, each aperture providing fluid communication between the annular channel and a respective fluid outlet. Therefore, the first aperture set provides fluid transfer of the first fluid from the first annular channel to the first fluid outlets.

It is particularly preferred that the cross sectional area of the annular channel is several times greater than the cross sectional area of the apertures so as to substantially minimise pressure differences between each of the apertures. It is particularly preferred that the ratio of the cross sectional area of the annular channel to the cross sectional area of the apertures is preferably greater than 5:1.

It is also preferred that the cross-sectional area of at least one of the annular channels in the region of the respective inlet port is greater than the cross-sectional area of the said annular channel in a region remote from the inlet port. It is preferred that the cross-sectional area of the annular channel decreases continuously from a region proximate to the respective inlet port to a region remote from the respective inlet port.

The device typically includes an annular channel for each fluid inlet port. In addition, the device may preferably include an aperture set for each annular channel. Therefore, for example, the device will include an annular channel and an aperture set for each fluid inlet port.

Preferably, the device further includes a flow restrictor. The flow restrictor is typically arranged to maintain fluid through the manifold at a predetermined pressure and/or balance the flow as it enters the outlets. The flow restrictor is typically arranged in a distribution passageway in the distribution element such that, in use, fluid flows from an aperture in the channel, through the restriction means, to a respective fluid outlet.

It is envisaged that the flow restrictor may include the internal shape or configuration of the distribution passageway; the internal shape or configuration typically having an internal diameter which is predetermined such that a predetermined flow is obtained. Alternatively, the flow restrictor may include a length of pipe or tubing, for example, positioned in the distribution passageway. The pipe or tubing having an internal diameter which is predetermined such that a predetermined flow is obtained.

Each fluid inlet port is typically arranged to transfer a different fluid; however it is envisaged that the same fluid can be introduced through each fluid inlet, although, this is not preferred.

It is further envisaged that the manifold includes at least one further inlet port; each further inlet port arranged to provide fluid transfer from the inlet port to a respective annular channel.

Each aperture set typically includes several apertures, however, this is dependent upon the number of outlets for each fluid required by the end user.

The manifold can be manufactured from an inert material such as the polymer polyetheretherketone or glass, however, it is particularly preferred that the manifold is machined from stainless steel.

The distribution element can be manufactured from an inert material, such as the polymer polyetheretherketone or glass, however, it is particularly preferred that the distribution element is machined from stainless steel.

Whilst a number of geometric configurations are possible it is particularly preferred that each annular channel is arranged as concentric configurations. It is therefore further preferred that the apertures in each aperture set are also arranged as concentric configurations.

The device of the present invention is particularly suitable for use in an apparatus for distributing fluids to multiple microfluidic circuits. For example, a system comprising of two or more microfluidic circuits arranged on top of each other; such a system is known as a single stack system. However the distributor may be employed to function with multilayer stack configurations. The device is particularly useful when the microfluidic circuit requires supply of two or more different fluids, each fluid being split to feed two or more outlets.

A second aspect of the present invention therefore provides

(i) a device in accordance with the first aspect of the present invention; and
(ii) multiple microfluidic circuits arranged to receive the multiple fluid flows from the device.

The multiple microfluidic circuits may be provided by a segmented flow device for producing two or more segmented flows of liquid.

Furthermore, according to a third aspect of the present invention, there is provided a micro-reactor which includes: a device for producing a fluid flow at a substantially uniform rate including a first inlet port and a second inlet port, each inlet port arranged to provide fluid transfer from the respective inlet port to a respective annular channel;

a distribution element having a first aperture set and a second aperture set therein, each aperture set in fluid communication with the annular channel and comprising a plurality of apertures such that, in use, fluid is permitted to flow through an aperture to a respective fluid outlet; and a segmented flow device for producing two or more segmented flows of liquid.

The microreactor typically further includes a panel arranged over the segmented flow device, the panel being transparent to light in the ultraviolet, visible infrared and far-infrared spectrum. The transparent panel may be fabricated from a plurality of materials such as acrylic, fused silica, quartz, sapphire, Teflon AF and calcium fluoride, however glass is particularly preferred.

The distribution element or segmented flow device may be provided with a flow restrictor. The flow restrictor is typically arranged to maintain fluid at a predetermined pressure and/or balance the flow as it enters the outlets.

The device for producing a fluid flow at a substantially uniform rate is substantially as described hereinbefore with reference to the first aspect of the present invention. Hence, a fourth aspect of the present invention provides a micro-reactor which includes:

(i) a device for producing a fluid flow at a substantially uniform rate, which device includes:

a manifold having a first inlet port and a second inlet port, each inlet port arranged to provide fluid transfer from the inlet port to a respective annular channel; and

a distribution element having a first aperture set and a second aperture set therein, each aperture set including at least one aperture and being arranged to be in fluid communication with one of the annular channels such that fluid is permitted to flow from the annular channel through an aperture to a respective fluid outlet; and

(ii) a segmented flow device for producing two or more segmented flows of liquid.

As mentioned above, the device for producing a fluid flow at a substantially uniform rate is substantially as described hereinbefore with reference to the first aspect of the present invention, and may comprise those features described above with reference to the device of the first aspect of the invention. For example, the micro-reactor may be provided with a flow restrictor. The flow restrictor operates may have those features as described with reference to the device of the first aspect of the invention. Also, the flow restrictor may be arranged in a passageway in the segmented flow device (rather than being provided in the distribution element).

The present invention will now be described by way of example only, with reference to the accompanying drawings, wherein

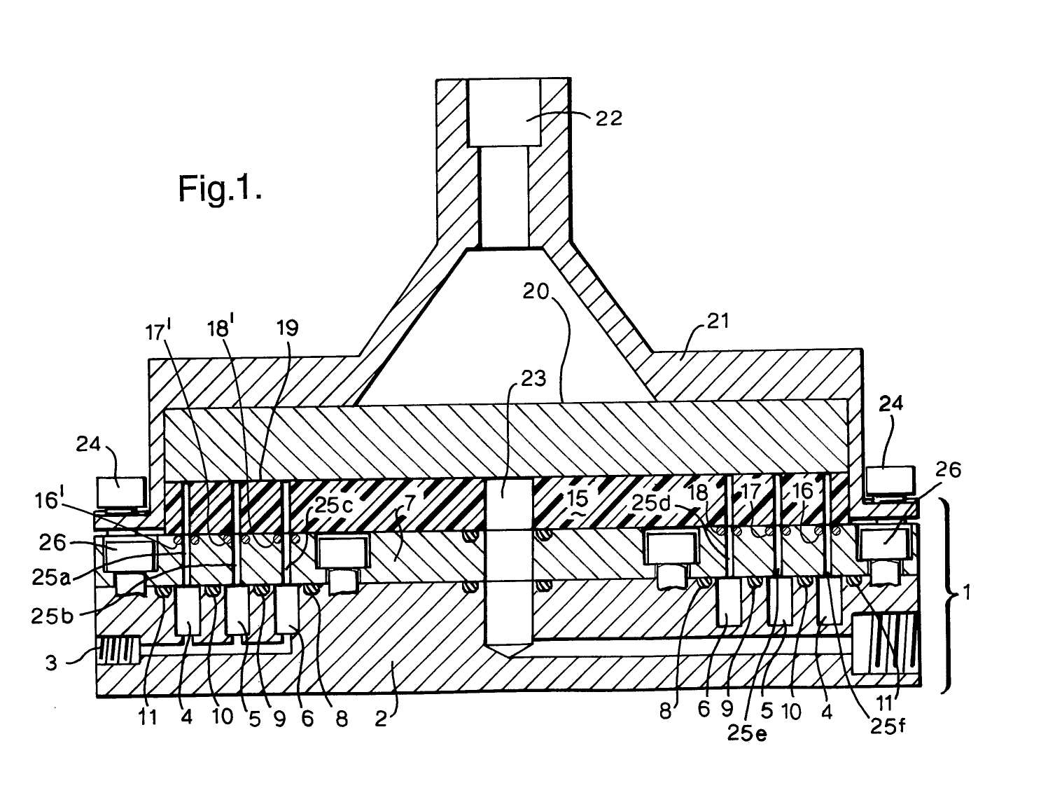

FIG. 1, represents a cross-sectional view of a device for producing a fluid flow at a substantially uniform rate according to the present invention, in use with a device for producing segmented flow;

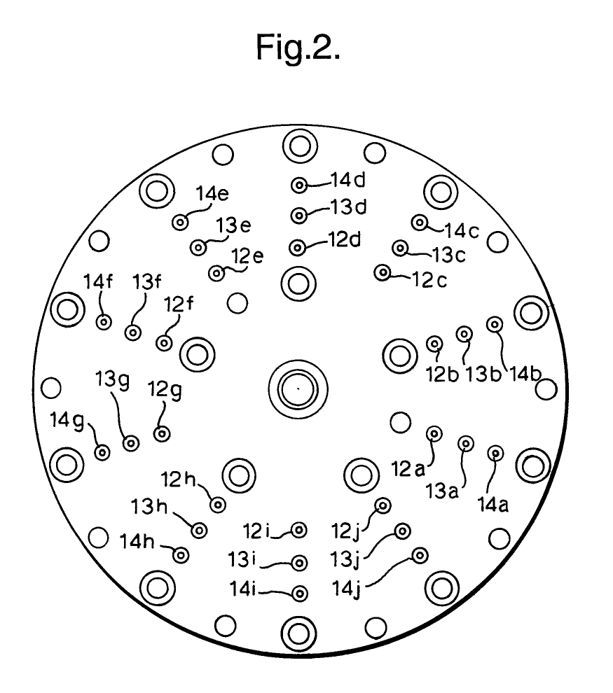

FIG. 2 represents a planar view of the distributor in accordance with the present invention;

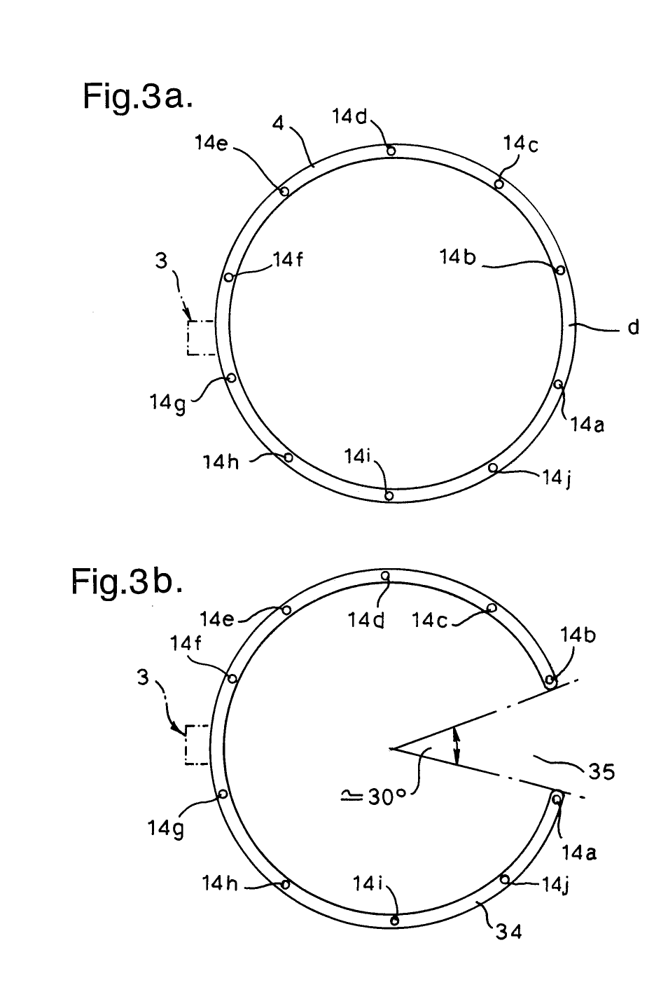

FIG. 3a represents a planar, schematic view of an annular channel used in the device of FIG. 1; and

FIG. 3b represents a planar, schematic view of an alternative annular channel that may be used in the device of the present invention.

Referring to the figures where like numerals have been used to represent like parts, there is provided a device for producing a fluid flow at a substantially uniform rate generally indicated by the numeral 1.

Three separate fluids are introduced into the manifold 2 through three inlets 3 (only one inlet is shown) and subsequently flow into three separate annular channels 4, 5 and 6. The three fluids may be oleic acid, or similar fatty acid, an aqueous solution of monomer or “macromer” and an aqueous solution of a photo-initiator.

The distributor 7 is fixed to the manifold with screws 26. The three fluids are kept separate by seals between the manifold and distributor by O-rings 8, 9, 10 and 11. The fluids flow from the annular channels 4, 5 and 6 through an array of 30 small apertures 12a-j (denoted hereafter as 12), 13a-j (denoted hereafter as 13) and 14a-j (denoted hereafter as 14) (see FIG. 2) which are spaced equidistantly around the centreline of each groove and through flow restrictors 25a, 25b, 25c, 25d, 25e, 25f, which restrict and/or balance the flow to the microfluidic circuits (not visible). The ratio of the cross sectional area of annular channels to the cross sectional area of the small holes is greater than 5 so as to substantially minimise pressure differences between each of the small holes.

Clamped to the distributor 7, is the polymer chip 15 containing the microfluidic circuits (not visible). The polymer chip has an array of small holes therein which are in line with the apertures 12, 13, 14 (see FIG. 2) in the distributor. The fluids are sealed between these two components by O rings 16, 16′, 17, 17′, 18, 18′. The fluids continue to flow through the chip 15 until they reach the top surface. Here they enter into the microfluidic circuit.

The fluids pass through the microfluidic circuit producing particles which pass from the chip into a central hole 23 and through the distributor 7 and manifold 2 where they are collected.

Clamped to the top of the chip 15 is a hydrophobic polymer gasket 19 and a UV transparent glass window 20. All the above clamping is performed by the cover member 21 which is fixed to the manifold 2 with screws 24. At the top of the cover is a hole 22 designed to accommodate a UV source to illuminate a specific area on the chip.

The annular channels 4, 5, 6 of FIG. 1 are complete, continuous channels as shown in FIG. 3a. An alternative channel is shown in FIG. 3b. In each Figure, the positions of the apertures 14a to 14j of distributor 7 are marked onto the annular channels, as is the position of inlet 3.

Referring to FIG. 3b, the channel 34 is broken, with a short arcuate break 35 in the channel 34. The break 35 has an angular dimension of about 30 degrees, and extends over a region corresponding to that between apertures 14a and 14b. These two apertures are the most remote from inlet 3. Referring to FIGS. 3a and 3b, it has been found that in the absence of a break in the annular channel in the region between apertures 14a and 14b, a “dead region” (denoted by reference letter ‘d’ in FIG. 3a) forms in the region of channel between the said two apertures. There is little flow in this “dead region”. Whilst the existence of the “dead region” does not affect the operation of the device, it is difficult to clean the device by running cleaning agent through the channel because the “dead region” does not clean properly. The break in the channel between apertures 14a and 14b removes the “dead region” and makes the channel 34 easier to clean.

The break in the channel may be formed by providing a blocking insert in a previously-complete, continuous channel (for example, by putting glue into a previously-complete, continuous channel). Alternatively, and more preferably, the break in the channel may be provided by failing to form a part of the channel that, if formed, would make a continuous, complete “O” channel.

The cross-sectional area of the channel 34 near to the inlet 3 is greater than that remote from the inlet i.e. in the region of the channel that corresponds to apertures 14a, 14b. This assists in obtaining uniform flow rates to all apertures 14a-14j, and this may be achieved by making the channel 34 deeper in the region of the inlet 3 and/or by making the channel 34 wider in the region of the inlet 3. For example, the channel 34 in the region of inlet 3 may be 5 mm deep and 5 mm wide, whereas in the region of the channel corresponding to apertures 14a, 14b, the channel 34 may be 2 mm deep and 2 mm wide.

1. A device for producing multiple fluid flows at substantially uniform rates and suitable for distributing fluids to multiple microfluidic circuits, which device includes: a manifold having a first inlet port and a second inlet port, each inlet port arranged to provide fluid transfer from the inlet port to a respective annular channel; a distribution element having a first aperture set and a second aperture set therein, each aperture set including at least one aperture and being arranged to be in fluid communication with one of the annular channels such that fluid is permitted to flow from the annular channel through an aperture to a respective fluid outlet.

2. A device according to claim 1 wherein each of the annular channels has a diameter of from about 50 mm to about 300 mm, a mean width of from about 1 mm to about 5 mm and a mean depth of from about 1 mm to about 5 mm.

3. A device according to claim 1 wherein the diameter of each aperture is from about 0.1 mm to about 3 mm.

4. A device according to claim 1 further including a flow restrictor arranged to maintain fluid through the manifold at a predetermined pressure and/or balance the flow as it enters the outlets.

5. A device according to claim 4 wherein the flow restrictor is arranged in a distribution passageway in the distribution element such that, in use, fluid flows from an aperture in the channel, through the flow restrictor, to a respective fluid outlet.

6. A device according to claim 5 wherein the flow restrictor includes the internal shape or configuration of the distribution passageway.

7. A device according to claim 5 wherein the flow restrictor includes a length of pipe or tubing positioned in the distribution passageway.

8. A device according to claim 1 wherein each aperture set includes two or more apertures.

9. A device according to claim 1 wherein one or more of the respective annular channels is continuous.

10. A device according to claim 1 wherein at least one of the aperture sets comprises two or more apertures, and the respective annular channel is provided with a break between two adjacent apertures.

11. A device according to claim 10 wherein the break has an angular dimension of 45 degrees or less.

12. A device according to claim 1 wherein the cross-sectional area of at least one of the annular channels in the region of the respective inlet port is greater than the cross-sectional area of the said annular channel in a region remote from the inlet port.

13. A device according to claim 1 wherein each aperture is arranged to permit fluid to flow from the annular channel to the fluid outlet.

14. A device according to claim 1, wherein each aperture set includes a plurality of apertures, each aperture providing fluid communication between the annular channel and a respective fluid outlet.

15. A device according to claim 1 wherein the ratio of the cross sectional area of the annular channel to the cross sectional area of the apertures is greater than 5:1.

16. A device according to claim 1 including an annular channel and an aperture set for each fluid inlet port.

17. A device according to claim 1 wherein the manifold includes at least one further inlet port, each further inlet port arranged to provide fluid transfer from the inlet port to a respective annular channel.

18. (canceled)

19. A micro-reactor which includes:
(i) a device for producing multiple fluid flows at substantially uniform rates and suitable for distributing fluids to multiple microfluidic circuits which device includes:
a manifold having a first inlet port and a second inlet port each inlet port arranged to provide fluid transfer from the inlet port to a respective annular channel;
a distribution element having a first aperture set and a second aperture set therein, each aperture set including at least one aperture and being arranged to be in fluid communication with one of the annular channels such that fluid is permitted to flow from the annular channel through an aperture to a respective fluid outlet; and
(ii) multiple microfluidic circuits arranged to receive the multiple fluid flows from the device.

20. A micro-reactor according to claim 19 wherein the multiple microfluidic circuits are provided by a segmented flow device for producing two or more segmented flows of liquid.

21. A micro-reactor which includes:
a device for producing a fluid flow at a substantially uniform rate including a first inlet port and a second inlet port, each inlet port arranged to provide fluid transfer from the respective inlet port to a respective annular channel; a distribution element having a first aperture set and a second aperture set therein, each aperture set in fluid communication with the annular channel and comprising a plurality of apertures such that, in use, fluid is permitted to flow through an aperture to a respective fluid outlet; and a segmented flow device for producing two or more segmented flows of liquid.

22. (canceled)
